(19) United States
(12) Patent Application Publication
(10) Pub. No.: US 2023/0417529 A1
(43) Pub. Date: Dec. 28, 2023

(54) METHODS AND APPARATUS TO ESTIMATE CABLE LENGTH

(71) Applicant: Texas Instruments Incorporated, Dallas, TX (US)

(72) Inventors: Raghu Ganesan, Bangalore (IN); Rallabandi Annapurna, Guntur (IN); Sucheth S. Kuncham, Bangalore (IN); Saravanakkumar Radhakrishnan, Aruppukottai (IN); Sumantra Seth, Bangalore (IN); Geet Modi, Bangalore (IN)

(21) Appl. No.: 18/072,458

(22) Filed: Nov. 30, 2022

(30) Foreign Application Priority Data
Jun. 22, 2022 (IN) 202241035911

(51) Int. Cl. G01B 7/02

(52) U.S. Cl. CPC G01B 7/026

(57) ABSTRACT

An example first device includes: processor circuitry configured to establish a cable communication; analog to digital converter circuitry configured to sample cable voltages over time; echo estimator circuitry configured to determine a plurality of echo coefficients corresponding to the plurality of voltages; and physical length estimator circuitry configured to: identify a first echo coefficient in the echo coefficients that satisfies a static threshold, the first echo coefficient corresponding to a near end echo; identify a second echo coefficient in the echo coefficients that satisfies a dynamic threshold, the second echo coefficient corresponding to a far end echo; and estimate the length of a cable for the cable communication based on the first echo coefficient and the second echo coefficient.

### RELATED APPLICATION

It is noted that this patent claims priority from Indian Provisional Patent Application Number 202241035911, which was filed on Jun. 22, 2022, and is hereby incorporated by reference in its entirety.

### TECHNICAL FIELD

This description relates generally to cable quality, and more particularly to methods and apparatus to estimate cable length.

### BACKGROUND

Modern vehicles often rely on a network of computational devices to perform various sensing and actuation tasks in a safe and reliable manner. In many examples, automotive manufactures implement wired connections to exchange data between computational devices. Wired connections may be advantageous over wireless communication in an automotive setting because wired connections generally enable faster data transfer and fewer transmission errors than wireless communication. To be considered safe for automotive use, a wire may be required to retain its quality while exposed to various amounts and types of heat, oils, chemicals, and acids found in a vehicle.

### SUMMARY

For methods and apparatus to estimate cable length, an example first device includes: processor circuitry configured to establish a cable communication; analog to digital converter circuitry configured to sample cable voltages over time; echo estimator circuitry configured to determine a plurality of echo coefficients corresponding to the plurality of voltages; and physical length estimator circuitry configured to: identify a first echo coefficient in the echo coefficients that satisfies a static threshold, the first echo coefficient corresponding to a near end echo; identify a second echo coefficient in the echo coefficients that satisfies a dynamic threshold, the second echo coefficient corresponding to a far end echo; and estimate the length of a cable for the cable communication based on the first echo coefficient and the second echo coefficient.

### BRIEF DESCRIPTION OF THE DRAWINGS

FIG. 1 is a block diagram of an example vehicle communication system.

FIG. 2 is a block diagram of two example Electronic Control Units (ECUs) connected by example connector circuitries and Ethernet cables of FIG. 1.

FIG. 3 is a graph describing an example of a signal received at example receiver circuitry of FIG. 2.

FIG. 4 are graphs representing intersymbol interference in the communication between the ECUs in FIG. 1.

FIG. 5 is a block diagram of the receiver circuitry of FIG. 2.

FIG. 6 is a block diagram of example signal conditioner circuitry of FIG. 5.

FIG. 7 is a graph describing an example of far end echo detection.

FIG. 8 includes example two graphs describing cable length estimations made by an example electrical length estimator circuitry of FIG. 6.

FIG. 9 is a flowchart representative of an example method that may be performed using machine readable instructions that can be executed and/or hardware configured to implement the receiver circuitry of FIG. 2, and/or, more generally, an ECU of FIG. 1 to compute Cable Quality Index (CQI).

FIG. 10 is a flowchart representative of an example method that may be performed using machine readable instructions that can be executed and/or hardware configured to implement the physical length estimator circuitry of FIG. 6, and/or, more generally, an ECU of FIG. 1 to compute a physical cable length estimation.

FIG. 11 is a flowchart representative of an example method that may be performed using machine readable instructions that can be executed and/or hardware configured to implement the electrical cable length estimator circuitry of FIG. 6, and/or, more generally, an ECU of FIG. 1 to compute an electrical cable length estimation.

FIG. 12 is a block diagram of an example processing platform including processor circuitry structured to execute the machine readable instructions and/or the operations of FIGS. 9, 10, 11 to implement an ECU of FIG. 1.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

Computational devices may rely on communication standards to describe how data can be both transmitted and received over a wired connection. One such communication standard is Ethernet, which is defined by the Institute of Electrical and Electronic Engineers (IEEE). IEEE regularly releases new versions of the Ethernet standard to describe how devices with increased performance capabilities can communicate more efficiently over a wire. As an example, the IEEE 402.3 bp standard enables 1 Gigabyte per second (Gbps) data transfer over single twisted pair cables. As used herein, a cable refers to one or more wires that are encased together in a sheathing. An example manufacturer may use the IEEE 402.3 bp standard to achieve the 1 Gbps data transfer rate necessary for high speed automotive applications. High speed automotive applications may include, but are not limited to, advanced driver assistance systems (ADAS). As used herein, cable communication refers to communication between two or more devices over a cable.

Cable quality is a primary factor in determining the maximum data transfer of a wired connection. For example, a cable that does not properly connect with input/output (I/O) pins on a computational device, is bent at an improper angle, is operating outside of an intended temperature range, has conducting material missing, etc., is unlikely to support a data transfer rate equal to that of a higher quality cable. As a result, manufacturers may desire real time cable quality information to safely execute high speed automotive applications with expected data transfer rates.

One previous solution to describe cable quality is Time Domain Reflectometry (TDR). TDR refers to transmitting a signal across a conductor and measuring the reflections of the signal to determine electrical characteristics of the conductor. In some examples, TDR may be used to determine the type of fault (such as a short or an open) that exists in a cable and the location of the fault along the cable. However, TDR requires transmission of a signal before reflection measurements can be recorded. As such, TDR is unable to measure cable quality while the cable is in use for normal data transmission.

Another previous solution to describe cable quality is Signal Quality Index (SQI). SQI refers to a value indicative of the Signal to Noise Ratio (SNR) at a receiver of a computational device connected to the cable. In some examples, previous solutions calculate a Mean Square Error (MSE) based on symbol decisions made in the receiver circuitry and map the MSE to an SQI value. SQI is a measure of signal quality rather than cable quality. As a result, a poor SQI value is not necessarily due to the quality of the cable. The poor SQI value may, also or alternatively, be due to other factors such as Radio Frequency (RF) interference, a fault in either computational device connected to the cable, etc.

Example methods, apparatus, and systems described herein accurately characterize the quality of an Ethernet cable, for instance, while the cable is actively transferring data. Specifically, examples herein describe techniques to generate a new parameter, Cable Quality Index (CQI). In some examples, CQI is a 3-bit value (e.g., an integer 0 through 7) mapped to a CQI_Ratio. The CQI_Ratio is defined in equation (1):

$$CQI\_Ratio = \frac{Electrical\_Cable \_Length}{Physical\_Cable \_Length} . \qquad ( 1 )$$

In equation (1), Electrical_Cable_Length refers to a manner of estimating the length of an example Ethernet cable based on its electrical characteristics, which may change based on the quality of the cable. In contrast, the Physical_Cable_Length of equation (1) refers to a manner of estimating the length of the example Ethernet cable using a physical attribute, such as the round trip delay of a signal, that does not change based on the quality of the cable. Advantageously, CQI_Ratio describes the magnitude of any loss in cable quality by comparing the dynamic Electrical_Cable_Length parameter to the static Physical_Cable_Length parameter. “Dynamic refers to the parameter changing based on the quality of the cable. Whereas, “static” refers to the parameter not changing based on the quality of the cable. Physical_Cable_Length and Electrical_Cable_Length are described further in the teachings of this description.

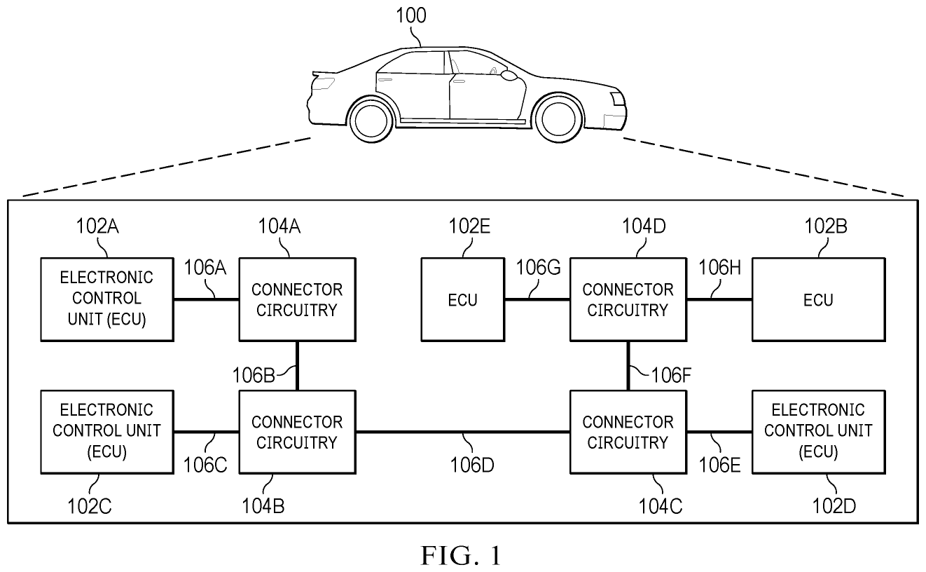

FIG. 1 is a block diagram of an example vehicle communication system. FIG. 1 includes an example vehicle 100, example ECUs 102A, 102B, 102C, 102D (collectively referred to as ECUs 102), example connector circuitry 104A, 104B, 104C, 104D (collectively referred to as connector circuitries 104), and example Ethernet cables 106A, 106B, 106C, 106D, 106E, 106F, 106G, 106H (collectively referred to as Ethernet cables 106).

The vehicle 100 of FIG. 1 is any vehicle that uses full-duplex Ethernet to send and receive data between ECUs 102. The vehicle 100 includes multiple systems which provide various functionalities. Example vehicle systems include but are not limited to the suspension, brakes, air conditioning, instrument panels, seat modules, transmission, batteries, engine, etc.

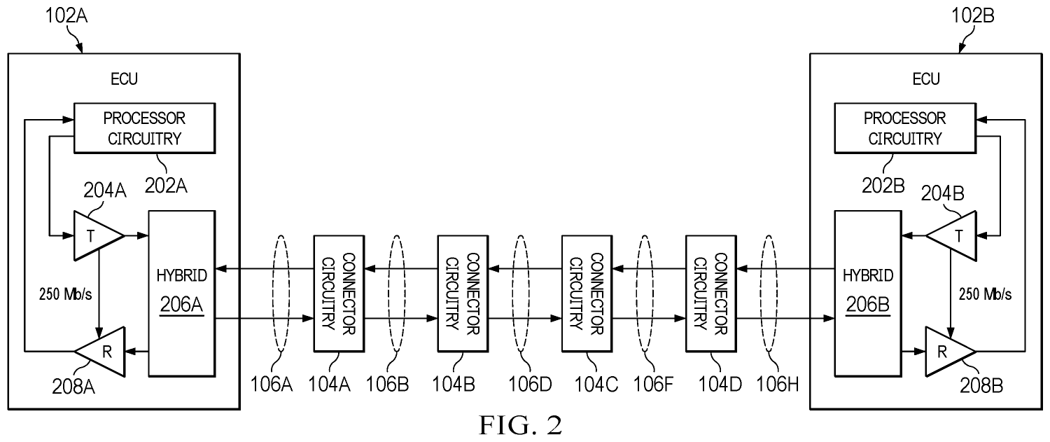

Each of the ECUs 102 of FIG. 1 implemented in this description controls a system of the vehicle 100. An ECU 102A may control a vehicle system by receiving information from another ECU 102B and causing an action to occur in the vehicle system based on or responsive to the received information. For example, the ECU 102A controls an engine and transmit rotational speed and/or torque information to ECU 102B which controls a transmission. Based on or responsive to the received rotational speed and/or torque information, the ECU 102B may send a signal to the transmission to shift gears. In some examples, the vehicle may contain a different number of ECUs than the system of FIG. 1. The ECUs 102 are described further in connection with FIG. 2.

The connector circuitries 104 connect multiple devices together to complete a local area network (LAN) within the vehicle 100. For example, connector circuitry 104C connects to ECUs 102B, 102E, and to connector circuitry 104D. The number of connector circuitries 104 may depend on the number of ECUs 102. In some examples, the number of connector circuitries 104 may be different than the system of FIG. 1. While destination devices such as the ECUs 102 or Ethernet switches may interpret, modify, and/or generally interact with the signals within the Ethernet cables 106, the connector circuitries 104 are passive, intermediate connectors that only forward a signal from a source device (e.g., ECU 102A) to a destination device (e.g., ECU 102B). Examples of connector circuitries 104 include, but are not limited to, TE Connectivity® MATEnet connectors.

The connector circuitries 104 help reduce the total number of Ethernet cables 106 used to implement the LAN of FIG. 1. For example, suppose each of the ECUs 102 are connected to all the other ECUs 102, but the connector circuitries 104 were not used within the vehicle 100. In such examples, a given ECU 102A would have four direct connections to the other ECUs 102B, 102C, 102D, resulting in ten total Ethernet cables in the vehicle 100. With the connector circuitries 104, however, the vehicle 100 has only eight Ethernet cables 106. Also, the ECU 102A can access the other ECUs 102B, 102C, 102D with one direct connection to a corresponding connector circuitry 104A instead of the four direct connections in the foregoing example. Furthermore, because the connector circuitries 104 may be physically located in between the ECUs 102, the average length of the eight Ethernet cables 106 may be less than the average length of the ten Ethernet cables from the foregoing example. Since shorter Ethernet cables can generally support higher performance metrics than longer Ethernet cables, manufacturers may implement the connector circuitries 104 to reduce the average length of the Ethernet cables 106 to enable the LAN to support high speed automotive applications.

The Ethernet cables 106 may be automotive-grade cables that connect the connector circuitries 104 to one another and to the ECUs 102. In the example of FIG. 2, each of the Ethernet cables 106 implements one or more communication channels. The communication channels may be implemented by various physical mediums. Examples of physical mediums used to implement Ethernet include, but are not limited to, a twisted pair of copper wires, fiber optics lines, etc. As the vehicle 100 is used, the quality of one or more of the Ethernet cables 106 may degrade over time for any number of reasons. Such reasons include, but are not limited to, exposure to extended amounts of heat, exposure to various amounts and types of oils, chemicals, and acids, repeated mechanical stresses, etc. Advantageously, the ECUs 102 can determine CQI values for the Ethernet cables 106 by using the normal transmission of data between devices to estimate physical cable lengths and electrical cable lengths.

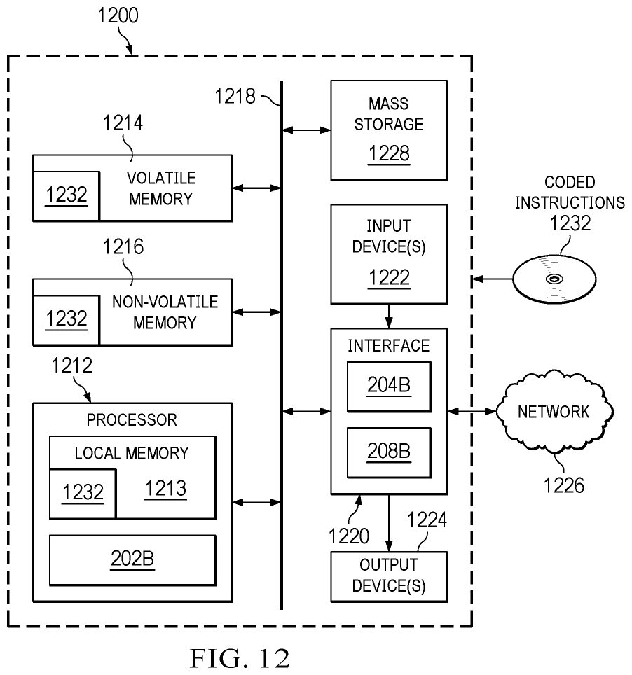

FIG. 2 is a block diagram of two ECUs 102A, 102B connected by the connector circuitries 104 and Ethernet cables 106A, 106B, 106D, 106F, 106H of FIG. 1. The ECUs 102 of FIGS. 1, 2 may be instantiated (e.g., creating an instance of, brought into being for any length of time, materialized, implemented, etc.) by a processor platform 1200 as described in FIG. 12. The ECU 102A includes example processor circuitry 202A, example transmitter circuitry 204A, example hybrid circuitry 206A, and example receiver circuitry 208A. Similarly, the ECU 102B includes example processor circuitry 202B, example transmitter circuitry 204B, example hybrid circuitry 206B, and example receiver circuitry 208B. The ECUs 102 may include additional digital circuitry (e.g., logic circuitry), analog circuitry (e.g., amplifiers, filters, transistors, etc.), converters (e.g., voltage converter, voltage regulators, analog-to-digital converters and/or digital-to-analog converters), sensors, memory, processor, state machine, microcontroller, microcomputer, and/or software that is not illustrated in FIG. 2 for simplicity.

The processor circuitry 202A of FIG. 2 executes instructions to control the vehicle system corresponding to the ECU 102A. The instructions could be for any purpose, including but not limited to, sensing, signal processing, and actuation applications related to the vehicle system. In some examples, the instructions cause the processor circuitry 202A to communicate with (i.e., transmit data to and/or receive data from) the processor circuitry 202B of the ECU 102B. Similarly, the processor circuitry 202B of FIG. 2 executes instructions to control the vehicle system corresponding to the ECU 102B and to communicate with the processor circuitry 202A. The processor circuitries 202A, 202B may be implemented using any type of processor architecture. Processor architectures include, but are not limited to, programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

The transmitter circuitry 204A receives instructions from the processor circuitry 202A. Based on or responsive to the instructions, the transmitter circuitry 204A generates an analog signal that is compatible with the Ethernet standard. The signal includes data that the processor circuitry 202A seeks to provide to the processor circuitry 202B. Similarly, the transmitter circuitry 204B uses instructions from the processor circuitry 202B to generate a signal with data intended for the processor circuitry 202A.

In the example of FIGS. 1, 2, the LAN network implements a full-duplex Ethernet communication protocol. Full duplex refers to the simultaneous communication of two or more devices in both directions. Accordingly, the transmitter circuitry 204A can send a first signal to the receiver circuitry 208B at the same the transmitter circuitry 204B sends a second signal to the receiver circuitry 208A. During full duplex communication, the electromagnetic field of a first communication channel (e.g., a channel that sends data from transmitter circuitry 204A to receiver circuitry 208B) may interfere and/or blend with the electromagnetic field of the complimentary channel (e.g., a channel that sends data from transmitter circuitry 204B to receiver circuitry 208A). Such interference may be referred to as cross talk. In some examples, cross talk can distort the performance of the Ethernet cables 106 by blending transmit and receive signals in a single channel. In many examples, cross talk is mitigated by shielding the two wires of a twisted pair cable and using a differential signal.

To implement a differential signal and prevent cross talk, the signal in one wire of the twisted pair may be phase shifted relative to the signal in the other wire. In such a configuration, a given wire within the twisted pair includes both a transmit and a receive signal. The hybrid circuitries 206A, 206B connect to the physical medium of the Ethernet cables 106 and separate the transmit and receive signals, thereby enabling full duplex communication. For example, the hybrid circuitry 206B connects to the Ethernet cable 106H, the transmitter circuitry 204B, and the receiver circuitry 208B. The hybrid circuitry 206B may delay and scale the transmitter signal from the transmitter circuitry 204B onto the Ethernet cable 106H.

The hybrid circuitry 206B may also apply an inverting operation to remove the transmitter signal and extract the receiver signal for the receiver circuitry 208B. For example, to remove the transmitter signal, the hybrid circuitry 206B estimates the reflections of the transmitter signal that occur from any impedance mismatch on the communication channel. Such impedance mismatches include those seen at the connector circuitries 104, as well as transitions between different physical mediums that occur from connecting an IC (e.g., the hybrid circuitry 206B) to the ECU 102B. For example, one or more transitions between the magnetic layers, lead frame point, soldering point, and bond wires may cause impedance mismatches.

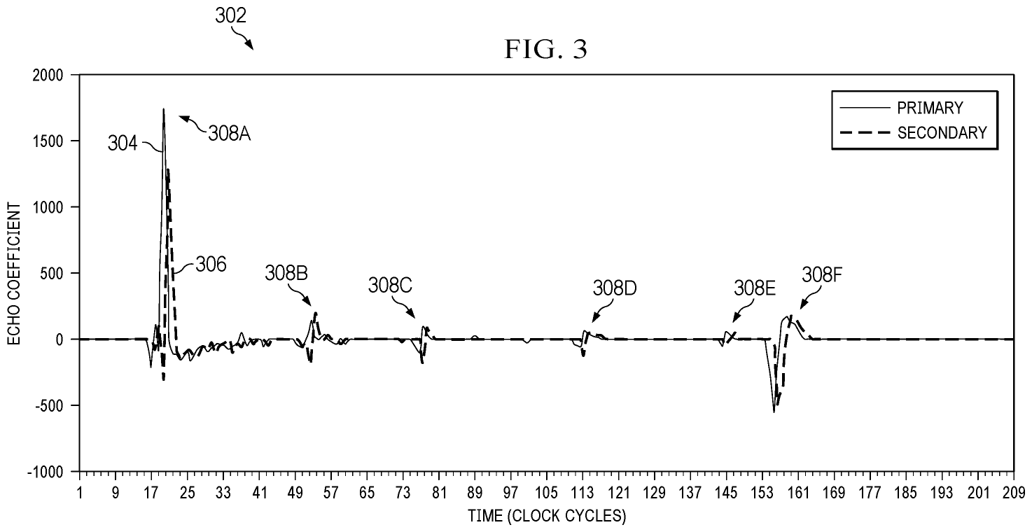

The estimation of the transmitter signal may be imprecise due to variations between types of components, the operating environment, etc. As a result, some of the transmitter signal may still be present after the hybrid circuitry 206B applies the inverting operation. The remaining transmitter signal results in a reflection that appears on the signal obtained by the receiver circuitries 208B. An example reflection is described further in connection with FIG. 3.

The receiver circuitry 208A receives an analog signal from the hybrid circuitry 206A via the Ethernet cable 106A and the LAN of FIG. 1. The receiver circuitry 208A converts the analog signal into instructions and/or data interpretable by the processor circuitry 202A. To produce interpretable instructions and/or data, the receiver circuitry 208A performs operations that include but are not limited to Analog to Digital Conversion (ADC), echo cancellation, and channel equalization. The receiver circuitry 208A also performs both physical cable length estimation and electrical cable length estimation based on the echo cancellation and channel equalization operations. Similarly, the receiver circuitry 208B converts an analog signal from the hybrid circuitry 206B into instructions and/or data interpretable by the processor circuitry 202B. The receiver circuitry 208B also performs both physical cable length estimation and electrical cable length estimation based on the echo cancellation and channel equalization operations. The receiver circuitry 208B is described further in connection with FIG. 3. Furthermore, while examples described herein may refer to receiver circuitry 208B for consistency, physical cable length estimation, electrical cable length estimation, and CQI calculation may be implemented by any of the receiver circuitry corresponding to ECUs 102 of FIG. 1.

In some examples, transmitter circuitry 204A and the corresponding receiver circuitry 208A may be referred to as components of an Ethernet PHY. An Ethernet PHY refers to circuitry responsible for implementing the physical layer of the Open Systems Interconnection (OSI) model in Ethernet capable devices. In some examples, the ECUs 102A, 102B may implement additional circuitry not illustrated in FIG. 2 to enable Ethernet PHY functionality.

The transmission of data over the Ethernet cables 106 of FIGS. 1, 2 causes a final signal received at an example receiver (e.g., receiver circuitry 208B) to differ from the original signal sent by the corresponding transmitter circuitry 204A. Differences between an original transmitted signal and a final received signal may have a variety of causes. One cause of the difference between signals are echoes. An echo refers to a transmitted signal that is reflected onto a received signal. For example, when transmitter circuitry 204B sends a first signal to the receiver circuitry 208A, a portion of the first signal is reflected onto a second signal sent from the transmitter circuitry 204A to the receiver circuitry 208B. Specifically, the first signal may be reflected onto the second signal a first time at the hybrid circuitry 206B, a second time at the connector circuitry 104D, a third time at the connector circuitry 104C, a fourth time at the connector circuitry 104B, a fifth time at the connector circuitry 104A, and a sixth time at hybrid circuitry 206A. The reflections may result in differences between the original transmitted signal and the final received signal, which are referred to as echoes. In the foregoing example, the receiver circuitry 208B identifies the six echoes and cancels the echoes when recovering the original transmitted signal. Advantageously, the receiver circuitry 208B uses timing information obtained from the echo cancellation process to estimate a physical cable length. Echoes are described further in connection with FIG. 3.

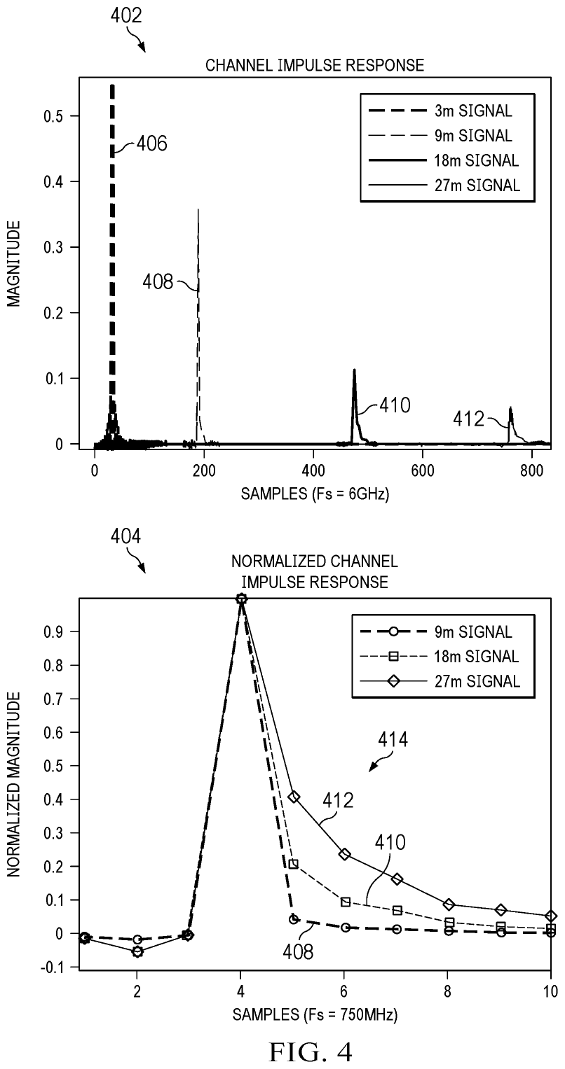

A second cause of differences between an original transmitted signal and a final received signal is intersymbol interference (ISI). When transmitted over a physical medium, a high voltage from an impulse signal spreads over time, causing pre-cursor and post-cursor voltages. ISI refers to a phenomenon where pre-cursor voltages and post-cursor voltages from different impulses (i.e., different symbols) overlap in time. The pre-cursor voltages and post-cursor voltages that occur during ISI may constructively or destructively sum to cause noise in the received signal. The receiver circuitry 208B may use equalization techniques to identify and mitigate ISI. Advantageously, the receiver circuitry 208B also uses the identified ISI to estimate an electrical cable length based on a proportional relationship between the length of a cable and the amount of voltage spread. As used herein, a cable voltage refers to a voltage from a cable. ISIs are described further in connection with FIG. 4.

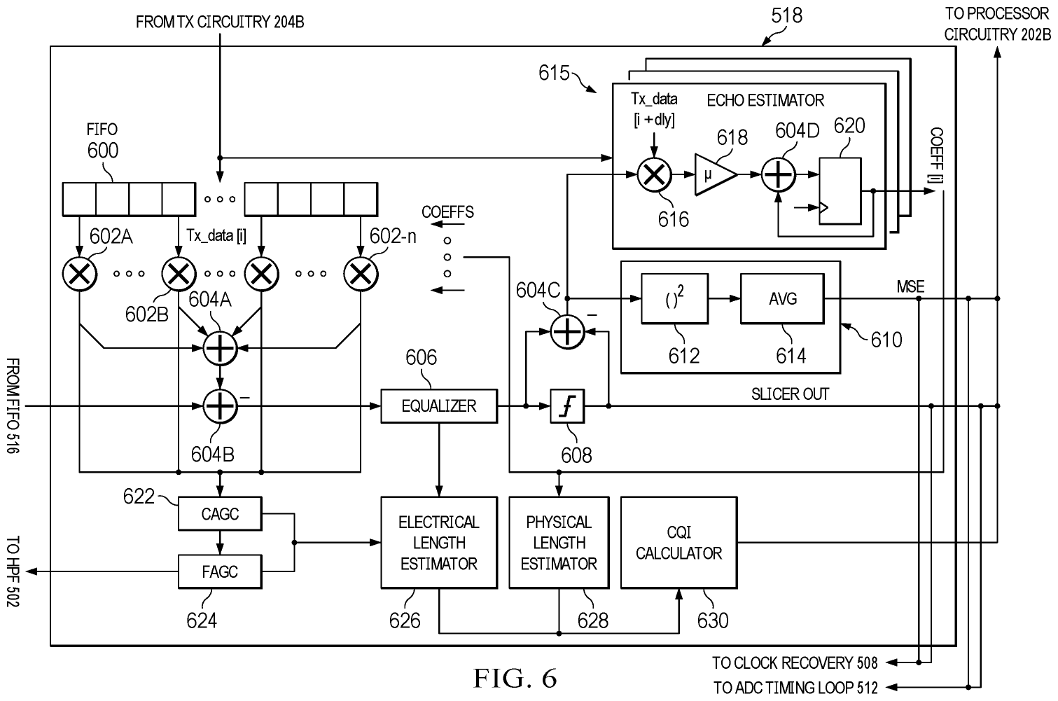

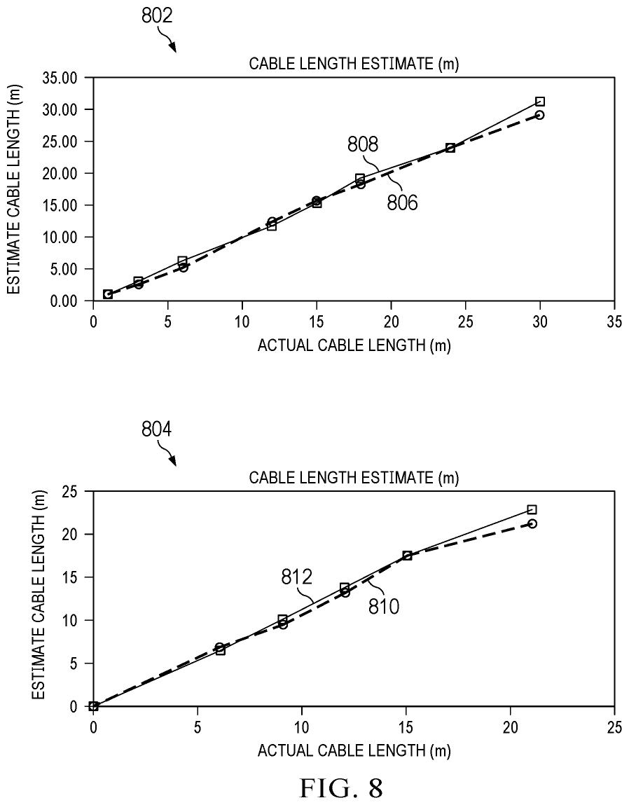

A third cause of differences between an original transmitted signal and a final received signal is attenuation. Signal attenuation refers to the loss of strength (i.e., the decrease in magnitude) of a signal that travels over a physical medium. In general, the attenuation of a signal travelling over a cable and the length of the cable are proportionate. To counteract attenuation, the receiver circuitry 208B uses an amplifier to increase the magnitude of the received signal. Because gain is proportionate to the insertion loss (the power lost from the inserting a cable into a port) of a cable, gain is also proportionate to the length of cable. Advantageously, the receiver circuitry 208B uses a gain of the receiver amplifier to estimate an electrical cable length. Gain estimation is described further in connection with FIGS. 6, 8.

Cable length estimations based on gain or ISI may be referred to as electrical cable length because the length estimations may change as the quality of the cable changes. Advantageously, the receiver circuitry 208B combines two different electrical characteristics (gain and ISI) to accurately describe the quality of the Ethernet cables 106. Furthermore, the physical cable length estimation serves as a reference value because the timing of echoes in the final received signal does not change with the quality of the cable. As such, the receiver circuitry 208B can determine a CQI value that accurately describes the quality of the Ethernet cables 106 while the ECUs 102A, 102B communicate with one another.

FIG. 3 is a graph describing an example of a signal received at the receiver circuitry of FIG. 2. FIG. 3 includes an example graph 302. The example graph 302 includes example signals 304, 306, and example echoes 308A, 308B, 308C, 308D, 308E, 308F, (collectively referred to as echoes 308).

The graph 302 represents the noise in the final received signals measured at the receiver circuitries 208A, 208B. Accordingly, the signal 304 represents voltage measured at receiver circuitry 208A that does not contain data from the transmitter circuitry 204B. Similarly, the signal 306 represents voltage measured at receiver circuitry 208B that does not contain data from the transmitter circuitry 204A.

The x axis of the graph 302 represents time, in a number of clock cycles, that have passed since an original transmitted signal was sent. Accordingly, at t=0, the transmitter circuitry 204A sends data to the receiver circuitry 208B, and the transmitter circuitry 204B sends data to the receiver circuitry 208A.

The y axis of the graph 302 represents the magnitude of the final received signal relative to the original transmitted signal. For example, consider the echo 308A, which refers to a local maxima in the signal 306 at approximately x=19, y=1250. Using the foregoing data point, the graph 302 shows that approximately 19 clock cycles after transmitter circuitry 204B sent a signal to receiver circuitry 208A, the voltage at the receiver circuitry 208B is approximately 1250 times larger in magnitude than the voltage that was expected from transmitter circuitry 204A. In some examples, the magnitude of the final received signal relative to the original transmitted signal is referred to as the echo coefficient. Furthermore, because the echo coefficient is relative to an original transmitted signal, a hypothetical received signal without noise would have a y value of 0 in the graph 302.

The graph 302 includes a number of local maxima or minima where the magnitude of noise increases. For example, in the signal 306, echo 308A is a first amount of noise that occurs when the signal sent from transmitter circuitry 204B reflects off the physical medium transitions inside an integrated circuit (IC) package. Physical medium transitions may include, but are not limited to, a signal transition between the magnetic layers, lead frame point, soldering point, and bond wires of an IC. Schematically, the physical medium transitions occur between the hybrid circuitry 206B (which is implemented by an IC), and the Ethernet port that connects to the ethernet cable 106H. The reflection off the physical medium transitions returns to the receiver circuitry 208B and is shown in FIG. 3 as echo 308A. Similarly, echoes 308B, 308C, 308D, 308E are caused when the transmitted signal reflects at each of connector circuitries 104D, 104C, 104B, and 104A, respectively, and return to the receiver circuitry 208B. In some examples, echoes from reflections off hybrid circuitry 206 may be larger in magnitude in echoes from reflections off the connector circuitries 104. The difference in magnitudes may occur because the signal reflection caused by a transition of different physical mediums at a hybrid circuit causes more noise than a signal reflection caused by transition of similar physical mediums at the connector circuitries 104.

The echo 308F represents noise that occurs when the signal sent from transmitter circuitry 204B reflects on the hybrid circuitry 206A and returns to the receiver circuitry 208B. In some examples, the echo that reflects off the hybrid circuitry furthest from the receiver may be referred to as a far end echo. Similarly, the echo that reflects off the hybrid circuitry closest to the receiver circuitry may be referred to as a near end echo. For example, in FIG. 3, echo 308A may be identified as the near end echo of the signal 306.

Advantageously, the receiver circuitry 208B compares when echo 308A (i.e., the near end echo in this example) and echo 308F (i.e., the far end echo in this example) occur in the signal 306B to determine a round trip distance. As used herein, round trip distance may refer to the distance a signal travels when reflecting off a received device and returning to the transmitting device. For example, if the total length of the Ethernet cables 106 was known, the round trip distance for the signal 306 could be described as 2×length(Ethernet Cables₁₀₆). Because the exact length of the Ethernet cables 106 is unknown due to degradation, the receiver circuitry 208 may calculate round trip distance using equation (2):

RoundTrip=(FarEndEcho−NearEndEcho)×Wave Propogation Speed. (2)

In equation (2), RoundTrip refers to the round trip distance, in meters, FarEndEcho refers to the timestamp of the far end echo, in seconds, NearEndEcho refers to the timestamp of the near end echo, in seconds, and Wave Propagation Speed refers to the speed that information propagates through the Ethernet cables 106 in meters per second. In some examples, the wave propagation speed of copper wires may be between 0.55c and 0.77c, where c refers to the speed of light. The receiver circuitry 208B may use the round trip distance to estimate a physical cable length using equation (3):

$$Cable Length = Round Trip \times \frac{Symbol Rate}{2 \times Propagation Delay Factor} . \qquad ( 3 )$$

In equation (3), CableLength refers to a physical cable length estimation, in meters, RoundTrip refers to the round trip distance, in meters, and SymbolRate is a unit-less value that refers to the ratio between the number of bits that are transmitted per second and the number of symbols that are transmitted per second. For example, a 1000 Mbps Ethernet connection may require a total transmission rate of 1125 megabits transmitted per second due to a need for additional error correction bits. In some examples, a 1000 Mbps Ethernet protocol may utilize Pulse Amplitude Modulation 3 (PAM3). Under PAM3, each analog symbol is transmitted at one of three pre-determined voltages, and two consecutive symbols are interpreted together as a three bit value. Therefore, PAM3 transmits 3/2=1.5 bits per symbol. In order to transmit 1125 megabits per second under PAM3, the ECUs 102 would transmit 1125e6/1.5=750e6 symbols per second (i.e., transmit at a 750 MHz frequency). As such, in the foregoing example,

$$Symbol Rate = \frac{1125 e 6}{750 e 6} = \frac{4}{3} .$$

In equation (3), PropagationDelayFactor refers to the number of clock cycles that pass for every one sample of the received signal. In some examples, a sample of the received signal is referred to as a tap. For example, a PropagationDelayFactor equal to 1 indicates that a sample is recorded every clock cycle. In some examples, a different ratio of clock cycles and taps may be used, resulting in a different value of the PropagationDelayFactor.

FIG. 4 illustrates graphs representing ISI in the communication between ECUs 102A, 102B. FIG. 4 includes example graphs 402, 404. The graphs 402, 404 include an example 3 m signal 406, an example 9 m signal 408, an example 18 m signal 410, an example 27 m signal 412, and example post-cursor ISI coefficients 414.

The graph 402 shows a channel response of a signal sent in multiple cables of different lengths. For example, the 3 m signal 406 represents a hypothetical signal that would be received at the receiver circuitry 208B if an impulse signal was sent from the transmitter circuitry 204A and the Ethernet cables 106 were 3 m total in length. Similarly, the 9 m signal 408, the 18 m signal 410, and the 27 m signal 412 represent a hypothetical signal that would be received at the receiver circuitry 208B if an impulse signal was sent from the transmitter circuitry 204A and the Ethernet cables 106 had lengths of 9 m, 18 m, and 27 m respectively.

The x axis of the graph 402 shows a number of samples that have been recorded since an impulse signal was sent at sample 0. The y axis of the graph 402 represents the relative magnitude of the received signal to a normalized voltage. The graph 402 shows that as the length of a cable increases, the impulse requires a larger number of samples to arrive at the receiver circuitry 208B and the relative magnitude of the impulse signal decreases.

The graph 404 shows the 9 m signal 408, the 18 m signal 410, and the 27 m signal 412 that have been normalized such that each impulse has a peak magnitude of 1.0 occurring at sample x=4. Because the graph 404 shows normalized responses, an ideal impulse signal would include y=1 Volt (V) at x=4, representing the peak voltage, and y=0 V at all other values of x. However, the graph 404 includes post-cursor ISI coefficients 414. The post-cursor ISI coefficients 414 are unwanted noise that occurs because the impulse has spread during the transmission across the Ethernet cables 106. ISI occurs when post-cursor ISI coefficients from different signals overlap, resulting in inaccurate readings.

The graph 404 shows how ISI is proportional to cable length. Specifically, as the length of a cable increases, the impulse spreads over a larger amount of time. For example, at sample x=5, the 27 m signal 412 has a normalized magnitude of approximately 0.4 V, the 18 m signal 410 has a normalized magnitude of approximately 0.2 V, and the 9 m signal 408 has a normalized magnitude of approximately 0.5 V. Also, at x=10, the 27 m signal 412 has a normalized magnitude of approximately 0.075 V, while the 18 m signal 410 and the 9 m signal 408 have normalized magnitudes of approximately 0 V. As a result, the receiver circuitry 208B may determine an electrical cable length estimation by identifying the magnitude and timing characteristics of post-cursor voltages. In some examples, the receiver circuitry 208B may use a look-up-table or similar data structure to map a given range of post-cursor voltage characteristics to an electrical cable length estimation. To identify the required post-cursor voltage characteristics, the receiver circuitry 208B uses outputs from equalizer filters. For example, the receiver circuitry 208B may implement Decision Feedback Equalizer (DFE), Digital Equalizer (DEQ), and Feed Forward Equalizer (FFE) filters. DFE, DEQ, and FFE filters are described further in connection with FIG. 6.

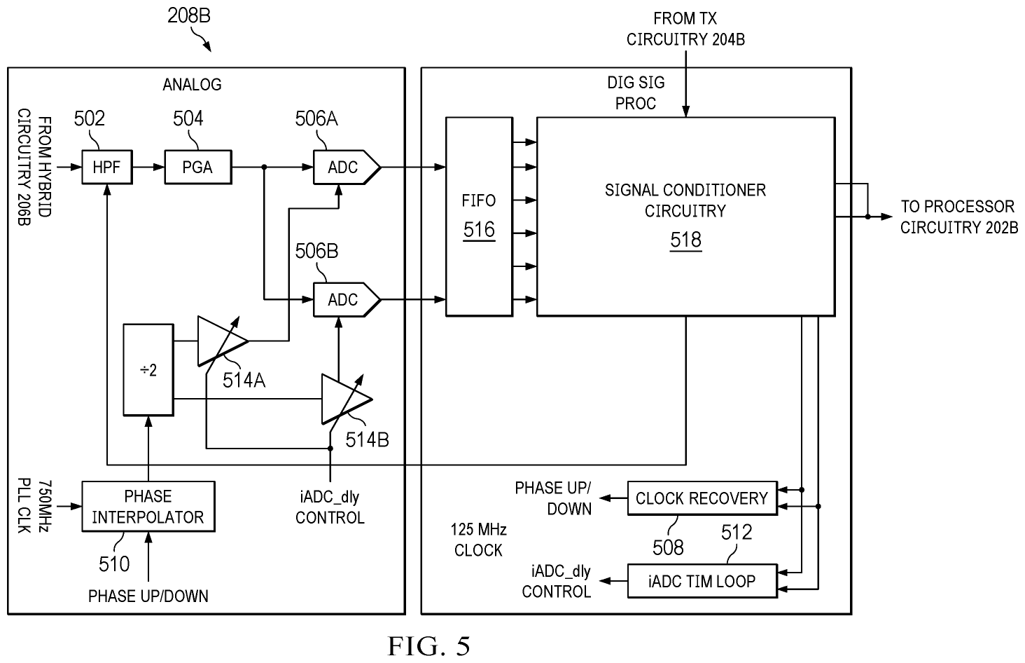

FIG. 5 is a block diagram of the receiver circuitry of FIG. 2. The receiver circuitry 208B includes an example High Pass Filter (HPF) 502, an example Programmable Gain Amplifier (PGA) 504, example Analog to Digital Converters (ADCs) 506A, 506B, example clock recovery circuitry 508, example phase interpolator circuitry 510, example ADC timing loop circuitry 512, example ADC controller circuitry 514A, 514B, an example First In First Out (FIFO) buffer 516, and example signal conditioner circuitry 518. In some examples, the receiver circuitry 208B may implement additional circuitry not illustrated in FIG. 5, for simplicity.

The HPF 502 receives the incoming received signal from the hybrid circuitry 206B. The HPF 502 extracts the portions of the signal that are above a pre-determined frequency and provides them to the PGA 504. The HPF 502 also increases the magnitude of the high frequency signal it provides to the PGA 504. The HPF 502 increases the magnitude based on control signals sent by the signal conditioner circuitry 518. The HPF 502 is described further in connection with FIG. 6.

The PGA 504 further amplifies the signal it receives from the HPF 502. The additional amplification enables the signal to be accurately sampled by the ADCs 506A, 506B. In some examples, the gain of the PGA 504 may be pre-determined by a manufacturer. Also or alternatively, the gain of the PGA 504 may be determined based on an Ethernet protocol.

Each of the ADCs 506A, 506B converts the analog signal received from the PGA 504 to digital bits. In the example of FIG. 5, the ADCs 506A, 506B are implemented to reduce the operating frequency and total power consumption of the ADC functionality. For example, the two ADCs 506A, 506B may both operate at 350 MHz and consume a first amount of power. In other examples, the receiver circuitry 208B may implement a single ADC that operates at 750 MHz and consume a second, greater amount of power. In some examples, multiple ADCs as shown in FIG. 5 may be referred to as interleaved ADCs. An example manufacturer may determine whether or not to interleave ADCs, and the exact number of ADCs, based on the system requirements of the receiver circuitry 208B and/or, more generally, the ECU 102B. The output of the ADCs 506A, 506B is a digital version of both the signal and the noise received at the HPF 502.

To produce digital bits, the ADCs 506A, 506B sample the signal at precise intervals that align with the peak voltage of a pulse. If the sample intervals are not precise, ISI may cause the ADCs 506A, 506B to sample one or more pre-cursor or post-cursor voltages and produce an incorrect digital bit.

The ADCs 506A, 506B rely on a clock signal to determine when to sample the output of the PGA 504. Clock circuits can be characterized by their phase and frequency, which naturally drift over time due to imperfections in the crystal oscillators (or other type of clock generating devices, such as bulk acoustic wave (BAW) devices) included in clock circuits. As such, the ADC controller circuitry 514A, 516B corrects for the phase and frequency drifts of the clock circuit using on phase and frequency adjustments determines by the clock recovery circuitry 508 and ADC timing loop circuitry 512, respectively. For example, the clock recovery circuitry 508 provides phase adjustment instructions to the phase interpolator circuitry 510, which uses the instructions and an external clock signal to provide modified phase parameters to the ADC controller circuitry 514A, 514B. In some examples, correction of the phase and frequency drifts of a clock to correct symbol decisions is referred to as symbol timing recovery.

The FIFO buffer 516 refers to an amount of memory that can store a plurality of bits. The FIFO buffer 516 may be implemented by any type of memory. For example, the FIFO buffer 516 may be a volatile memory or a non-volatile memory. The volatile memory may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory may be implemented by flash memory and/or any other desired type of memory device. The FIFO buffer 516 may store a number of consecutive bits from the ADC to support the Finite Impulse Response (FIR) filter functionality within the signal conditioner circuitry 518.

The signal conditioner circuitry 518 improves the quality of the signal stored in the FIFO buffer 516. For example, the signal conditioner circuitry 518 removes the effects of the echoes 308 and the effects of ISI from the received signal. The signal conditioner circuitry 518 also estimates both the physical cable length and electrical cable length in the teachings of this description. The signal conditioner circuitry 518 provides digital bits to the processor circuitry 202B. In some examples, the processor circuitry 202B obtains the modified bits from a memory of the ECU 102B where the output of the signal conditioner circuitry 518 is stored. The signal conditioner circuitry 518 is described further in connection with FIG. 6.

FIG. 6 is a block diagram of the signal conditioner circuitry 518 of FIG. 5. The signal conditioner circuitry 518 includes an example FIFO buffer 600, example multiplier circuitry 602A, 602B, . . . , 602-n, example adder circuitry 604A, 604B, 604C, example equalizer circuitry 606, example slicer circuitry 608, and example Mean Square Error (MSE) circuitry 610. The MSE circuitry 610 includes example scaler circuitry 612 and example averager circuitry 614. The signal conditioner circuitry 518 also includes example echo estimator circuitry 615. The echo estimator circuitry 615 includes example multiplier circuitry 616, example amplifier circuitry 618, example adder circuitry 604D, and example flip flop circuitry 620. The signal conditioner circuitry 518 also includes example Coarse Automatic Gain Control (CAGC) circuitry 622, example Fine Automatic Gain Control (FAGC) circuitry 624, example electrical length estimator circuitry 626, example physical length estimator circuitry 628, and example CQI calculator circuitry 630.

The FIFO buffer 600 stores samples from different points in time of an transmitted signal produced by the transmitter circuitry 204B. When a requisite number of samples are present in the FIFO buffer 600, each of the samples may be synchronously multiplied by a corresponding weight value using the multiplier circuitry 602A, 602B, . . . , 602-n. The corresponding weight values are determined by the echo estimator circuitry 615. The adder circuitry 604A then adds the products of the transmitted samples and the weight values together. In some examples, the FIFO buffer 600, multiplier circuitry 616, and adder circuitry 604A may be collectively referred to as echo canceller circuitry.

By multiplying the transmitted signal with the echo coefficients and summing the products, the echo canceller circuitry creates a replica of the noise that appears in the receiver signal stored in the FIFO buffer 516. The echo canceller circuitry provides the noise estimation to the adder circuitry 604B, which subtracts the noise estimation from a digital input signal stored in the FIFO buffer 516. Through this process, the adder circuitry 604B removes the echoes 308 from the receiver signal.

The use of the FIFO buffer 600, multiplier circuitry 602A, 602B, . . . , 602-n, and adder circuitry 604A, 604B implement a FIR filter that removes unwanted frequency components. A FIR filter has a finite duration. In some examples, the length of a FIR filter is referred to as a number of taps, n, that describes the number of samples that need to be stored in the FIFO buffer 516 to implement the filter. Increasing the number of taps may both increase the accuracy and the power consumption of the receiver circuitry 208B. For example, a cable 25 m in length may require approximately 216 taps to achieve a physical cable length estimation with −0.127 m resolution. In some examples, the number of taps is dependent on the symbol rate of the channel as described in equation (3).

The equalizer circuitry 606 further improves the quality of the obtained signal by adjusting the frequency bands of the signal. For example, the equalizer circuitry 606 may extract and/or adjust certain frequency components to remove the effects of ISI from the digital bits. In some examples, the equalizer circuitry 606 may be implemented by a DEQ, FFE, and a parallel DFE. In other examples, the equalizer circuitry 606 may be implemented by a different combination of equalizer circuits. Also or alternatively, in other examples, the equalizer circuitry 606 may be implemented by other types of equalizer circuits.

The slicer circuitry 608 of FIG. 6 samples the output of the equalizer circuitry 606. This input to the slicer circuitry 608 may be described as x(n). The example slicer circuitry 608 samples at a rate based on the clock signal used by the ADCs 506A, 506B. The slicer circuitry 608 then determines or decides symbols to map a filtered digital signal to a smaller number of bits based on the Ethernet protocol. For example, Under PAM3, each analog pulse is transmitted at one of three pre-determined voltages, and two consecutive pulses are interpreted together as a three bit value. When transmitted over the Ethernet cables 106, the received signal may become distorted and result in noise in between the three pre-determined voltages. The ADCs 506A, 506B digitalize this noise using a large number of bits (e.g., 256 bits) so that the echo canceller circuitry and equalizer circuitry 606 can use digital signal processing techniques to remove the noise. As a result, the output of the equalizer circuitry 606 is free of noise but mapped over an incorrect number of bits (e.g., 256 bits instead of 3 bits). In the foregoing example, the slicer circuitry 608 samples and converts the output of the equalizer circuitry 606 from a 256 bit value into a three bit value interpretable by the processor circuitry 202B using PAM3.

The output of the slicer circuitry 608 may be described as \hat{x}(n). The slicer circuitry 608 may provide an output to the clock recovery circuitry 508 and ADC timing loop circuitry 512. The slicer circuitry 608 may also provide an output to the processor circuitry 202B.

The adder circuitry 604C subtracts the input and output of the slicer circuitry 608 to form a difference signal, x(n)-\hat{x}(n). The adder circuitry 604C provides the difference signal to the multiplier circuitry 616 of the echo estimator circuitry 615 and to the scaler circuitry 612.

Within the MSE circuitry 610, the scaler circuitry 612 squares the difference value for a given symbol by multiplying the difference value by itself. In doing so, the scaler circuitry 612 receives an input that may be negative (e.g., the difference signal) and produces a scaler signal that is always positive.

Within the MSE circuitry 610, the averager circuitry 614 produces a rolling average using a small number of scaler values from the scaler signal. The number of scaler values may be any number of consecutive symbols. The rolling average values are collectively referred to as the MSE signal. The MSE signal represents an amount of error that exists in the slicer circuitry 608. The MSE circuitry 610 may provide the MSE signal to the clock recovery circuitry 508 and the ADC timing loop circuitry 512. In some examples, the MSE circuitry 610 may also provide the MSE signal to the processor circuitry 202B.

Within the echo estimator circuitry 615, the multiplier circuitry 616 multiplies the difference signal from the adder circuitry 604C with the transmitter signal produced by the transmitter circuitry 204B. The amplifier circuitry 618 further multiplies the product of the multiplier circuitry 616 by an adapting scaling factor, μ. In some examples, the scaling factor μ is determined by a manufacturer. The amplifier circuitry 618 provides an output to the adder circuitry 604D.

The adder circuitry 604D adds a sample from a current tap n of the amplified signal to a sample from the preceding tap n−1 of the amplified signal. The sample from the preceding tap n−1 is obtained by storing the current value of the signal into the flip flop circuitry 620 for one clock cycle.

The multiplier circuitry 616, amplifier circuitry 618, adder circuitry 604D, and flip flop circuitry 620 implement a Least Mean Square (LMS) algorithm to estimate the magnitude of the echoes 308. The echo estimator circuitry 615 provides the magnitude of the echoes 308, which may be referred to as echo coefficients, to the multiplier circuitries 602A, 602B, . . . , 602-n. In other examples, the echo estimator circuitry 615 uses other algorithms besides LMS to determine echo coefficients. Example algorithms to estimate echo coefficients include but are not limited to the Normalized Least Mean Square (NLLMS) algorithm, the Recursive Least Square (RLS) algorithm, the Geigel algorithm, the Cross Correlation algorithms, etc.

The CAGC circuitry 622 and the FAGC circuitry 624 determine the amount of gain that the HPF 502 applies to the signal received from the hybrid circuitry 206B. Specifically, the CAGC circuitry 622 provides a first gain value using first increments, and the FAGC circuitry 624 provides a second gain value using second, more precise increments. For example, the first gain value provided by the CAGC circuitry 622 is an integer value between 0 and a maximum supported gain. In such examples, the second gain value provided by the FAGC circuitry 624 is an increment of 0.01 between 0 and 1. In other examples, one or both of the CAGC circuitry 622 and FAGC circuitry 624 provides different ranges of gain at different increments. The total gain used by the HPF 502 to amplify the signal may be the product of the first gain value from the CAGC circuitry 622 and the second gain value from the FAGC circuitry 624. The CAGC circuitry 622 and FAGC circuitry 624 may determine the respective gain values based on instructions from the signal conditioner circuitry 518.

A previous technique to measure cable length is a Texas Instruments® diagnostic tool named Active Link Cable Diagnostics (ALCD). ALCD uses measurements from circuitry that imprecisely adjusts the gain of an attenuated signal. Such circuitry may function similarly to the CAGC circuitry 622. Because ALCD uses only coarse adjustment parameters, the system may produce relatively low accuracy of cable length estimations. For example, ALCD measurements of cable length may have an average of approximately 2 m of error. In practice, automotive cables may range between 0.5 m to 15 m in length. As a result, a 2 m error would have significant impacts on the cable length estimate and cable quality estimate. Furthermore, ALCD cannot be used by itself to determine cable quality. For example, when a cable is degraded, leading to a higher insertion loss, ALCD cannot be used to determine whether the cable is a degraded short cable or a high quality long cable.

The electrical length estimator circuitry 626 uses outputs from the equalizer circuitry 606 to determine an electrical cable length based on ISI. After the peak voltage of an impulse signal, the electrical length estimator circuitry 626 may describe subsequent post cursor voltages of an example Ethernet communication channel h using equation (4):

h_{CH}(n)=1+Σᵢ₌₁^{N}h(i)·δ(n−i) (4)

In equation (4), n refers to the index of a current sample, δ(n−i) refers to an impulse signal at index n−i, and h(i) refers to a nominal channel value at i. When filtered by the DEQ within the equalizer circuitry 606, the electrical length estimator circuitry 626 may describe the channel h using equation (5):

h_{DEQ}(n)=a·δ(n+1)+δ(n)+a·δ(n−1) (5)

In equation (5), a represents the coefficients of the DEQ filter, δ(n+1) represents the pre-cursor voltage, δ(n) represents the peak voltage of the impulse, and δ(n−1) represents the post-cursor voltage. Accordingly, coefficients a are equal on both pre-cursor and post-cursor voltage terms because the DEQ implements a symmetric filter. When filtered by the DFE within the equalizer circuitry 606, the electrical length estimator circuitry 626 may describe the channel h using equation (6):

h_{DFE}(n)=1+Σₖ₌₁^{M}h(k)·δ(n−k) (6)

In equation (6), the first post-cursor voltage is described when k=1. The electrical length estimator circuitry 626 may further estimate the channel output y using equation (7):

y(n)=x(n)+h₁·x(n−1)+h₂·x(n−2)+ (7)

In equation (7), x(n) represents a nth sample of the channel, x(n−1) represents one sample before the nth sample, etc. Furthermore, h₁ represents the magnitude of the signal present from the (n−1)th sample, h₂ represents the magnitude of the signal present from the (n−2)th sample, etc. In examples used herein, h₁, h₂, etc., may be referred to as ISI coefficients. The output of the DEQ filter, when using only the sample from the first ISI coefficient, may be characterized according to equation (8):

y_{DEQ}(n)=−a·y(n+1)+y(n)−a·y(n−1) (8)

When considering only the sample from the first ISI coefficient (e.g., k=1 in equation (6)), the output of the DFE filter may be characterized using the output of the DEQ, as described in equation (9):

y_{DFE}(n)=y_{DEQ}(n)+d₁·y_{DEQ}(n−1) (9)

In equation (9), d₁ refers to coefficients applied by the DFE filter. By substituting equation (8) into equation (9), and considering only the components with x(n), x(n−1), h₁, a, and d₁, the electrical length estimator circuitry 626 may simplify the output of the DFE as shown in equation (10):

y_{DFE}(n)=x(n)[1−a·h₁−a·d₁]+x(n−1)[h₁−a+d₁−a·h₁·d₁] (10)

To cancel ISI, the echo canceller circuitry implements circuitry that sets the coefficient of x(n)=0. The electrical length estimator circuitry 626 may implement this equality as described in equation (11):

h₁−a+d₁−a·h₁·d₁=0 (11)

As a result, the electrical length estimator circuitry 626 may determine the value of the ISI coefficient h₁ using equation (12):

h₁=a−d₁+a·h₁·d₁ (12)

Alternatively, because a·h₁·d₁ is the only second order term in equation (12), a·h₁·d₁<<a and a·h₁·d₁<<d₁. Therefore, in some examples, the electrical length estimator circuitry 626 may not compute a·h₁·d₁, resulting in equation (13):

h₁=a−d₁ (13)

Finally, the electrical length estimator circuitry 626 may use the ISI coefficient from either of equation (12) or (13), combined with a look-up table or similar data structure that describes the proportional relationship between ISI coefficients and cable length, to estimate a first electrical cable length.

The electrical length estimator circuitry 626 also uses the outputs of the CAGC circuitry 622 and FAGC circuitry 624 to determine another electrical cable length based on both coarse and fine gain adjustments to the HPF 502. In some examples, the electrical length estimator circuitry 626 determines a final electrical cable length estimation by performing a weighted average of the two length estimations based on ISI and gain. The physical length estimator circuitry 628 provides the final electrical cable length to the CQI calculator circuitry 630 for use in the computation of a CQI value. The electrical length estimator circuitry 626 is described further in connection with FIGS. 8, 9, 11.

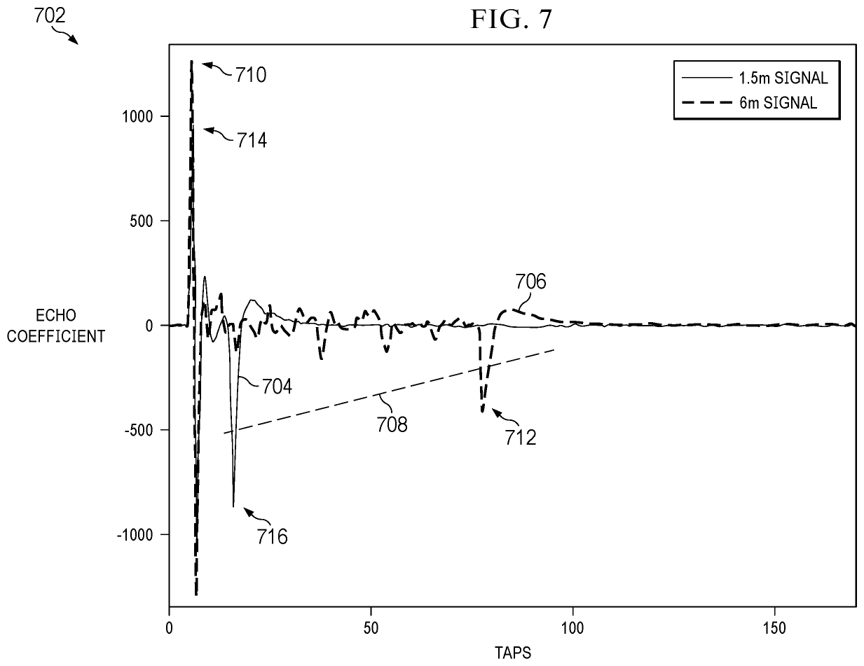

The physical length estimator circuitry 628 uses the echo coefficients from the echo estimator circuitry 615 to identify the near end echo and far end echo timestamps. The physical length estimator circuitry 628 may use the timestamps to compute equation (2) and/or equation (3) and produce a physical cable length. The physical length estimator circuitry 628 provides the physical cable length to the CQI calculator circuitry 630 for use in the computation of a CQI value. The physical length estimator circuitry 628 is described further in connection with FIGS. 7, 9, 10.

The CQI calculator circuitry 630 obtains an electrical cable length estimation and a physical cable length estimation from the electrical length estimator circuitry 626 and the physical length estimator circuitry 628, respectively. The CQI calculator circuitry 630 uses the length parameters to calculate the CQI_Ratio as described in equation (1) previously. The CQI calculator circuitry 630 also maps the CQI ratio to a CQI value. To map a CQI_Ratio to a CQI value, the CQI calculator circuitry 630 may identify a range of consecutive numbers that corresponds to each CQI value. For example, a CQI_Ratio within a first range of numbers is assigned CQI=0, a CQI_Ratio within a second range of values is assigned CQI=1, etc. The CQI calculator circuitry 630 determines the CQI value based on the corresponding range that contains the CQI_Ratio. The CQI calculator circuitry 630 provides the CQI value to the processor circuitry 202B.

FIG. 7 is a graph describing an example of far end echo detection. FIG. 7 includes an example graph 702, which includes an example 1.5 m signal 704, an example 6m signal 706, and an example dynamic threshold 708. The 1.5 m signal 704 includes an example near end echo 710 and an example far end echo 712. The 6 m signal 706 includes an example near end echo 714 and an example far end echo 716.

The graph 702 includes two signals that the physical length estimator circuitry 628 may receive from the multiplier circuitry 602A, 602B, . . . , 602-n. For example, the 1.5 m signal 704 represents the noise that may be present in a signal received at the receiver circuitry 208B when the Ethernet cables 106 are a total of 1.5 m in length. Similarly, the 6 m signal 706 represents the noise that may be present in a signal received at the receiver circuitry 208B when the Ethernet cables 106 are a total of 6 m in length.

The x axis of the graph 702 represents the indices of consecutive samples stored in the FIFO buffer 516, which may be referred to as taps. The x axis of the graph 702 is aligned with the time axis in that a tap with index n represents a sample of the transmitted signal that was recorded after a sample from tap index n−1 and before a sample from tap index n+1. The y axis of the graph 702 displays echo coefficients, which represent the relative magnitude of the voltage of the echoes 308 compared to the voltage of the actual transmitted data from the transmitter circuitry 204A.

The echo estimator circuitry 615 may identify the near end echo as the lowest index tap with an echo coefficient that crosses a threshold. The threshold may be an empirically determined value that identifies near end echoes for applicable cable lengths. For example, automotive cables range between 0.5 m to 15 m in length. As a result, a manufacturer may choose a threshold echo coefficient value that is less than near end echoes of 0.5 m to 15 m length cables but is greater than intermediate echoes of 0.5 m to 15 m length cables. The graph 702 shows that the difference between echo coefficients of the near end echoes 710, 714 is smaller than the difference between echo coefficients of the far end echoes 712, 716. Accordingly, in some examples, the echo estimator circuitry 615 may use a single, static threshold to identify near end echoes of various length cables.

While cable length may not affect the magnitude of near end echoes, cable length is inversely proportional to the magnitude of the far end echoes. As a result, in some examples, the magnitude of a far end echo in a cable with a first length may be smaller in magnitude than both a far end echo and an intermediate echo in a cable with a second length.

To avoid identifying an intermediate echo as a far end echo, the physical length estimator circuitry 628 may employ a dynamic threshold. For example, the dynamic threshold 708 represents different echo coefficient values that are used by the physical length estimator circuitry 628 to determine the tap index corresponding to a far end echo. The dynamic threshold 708 may be any set of echo coefficient values. In the graph 702, the dynamic threshold 708 refers to pre-determined values stored in the physical length estimator circuitry 628 that were empirically determined based on tests with a variety of brands of cables and a variety of cable lengths.

To identify a far end echo, the physical length estimator circuitry 628 may initially determine the highest tap index n that crosses the dynamic threshold 708. The tap index n may represent a sample from an intermediate echo that was caused by the aftereffects of the far end echo. The physical length estimator circuitry 628 then determines a window of consecutive coefficients in which the highest index is n. Because this window contains samples that were obtained before the tap index n, the samples in the window contain the far end echo. Finally, the physical length estimator circuitry 628 performs local maxima estimation on the echo coefficients within the sample window to identify which tap corresponds to the far end echo. The physical length estimator circuitry 628 may use any type of local maxima estimation algorithm on the sample window.

Also or alternatively, the physical length estimator circuitry 628 identifies a far end tap by amplifying the echo coefficients with the largest possible gain value supported by the receiver circuitry 208B. By amplifying the echo coefficients with a large gain, the physical length estimator circuitry 628 may determine a ratio between a maximum gain and the actual gain applied by the PGA 504. Because the ratio between the largest gain and the actual gain applied is proportional to cable length, the physical length estimator circuitry 628 may use the ratio to determine which tap index contains the far end echo. Advantageously, the use of a large gain and the use of nearest local maxima estimation results in the physical length estimator circuitry 628 identifying the far end echo with greater accuracy than it otherwise could using only a static threshold.

FIG. 8 includes two graphs comparing the performance of electrical cable length estimation with and without the a·h₁·d₁ term from equation (12). FIG. 8 includes example graphs 802, 804. The graph 802 includes example signals 806, 808. The graph 804 includes example signals 810, 812.

Both graphs 802, 804 display a multitude of estimations made for multiple cables that are known to have different lengths. The signals 806, 810 represent electrical cable lengths estimations formed on a first signal in a full duplex Ethernet cable, and the signals 808, 812 represent electrical cable length estimations formed using ALCD techniques on the complimentary second signal in the full duplex Ethernet cable.

The graph 802 represents electrical cable length estimations that were made by the electrical length estimator circuitry 626 using equation (13), where the computation of the ISI coefficient does not include the term a·h₁·d₁. In contrast, the graph 804 represents electrical cable length estimations that were made by the electrical length estimator circuitry 626 using equation (12), where the computation of the ISI coefficient does include the term a·h₁·d₁.

In the example of FIG. 8, length estimations in the graph 802 have a slightly greater precision than length estimations in the graph 804. As a result, a manufacturer may or may not choose to use extra computational resources to calculate the a·h₁·d₁ term. Advantageously, both graphs 802, 804 show length estimations that are more precise and more accurate than previous solutions. For example, ACLD techniques to estimate cable length may have an average of approximately 2 m of error, while the electrical cable length estimations shown in FIG. 8 and calculated using the teachings of this description have an average of approximately 0.2 m of error.

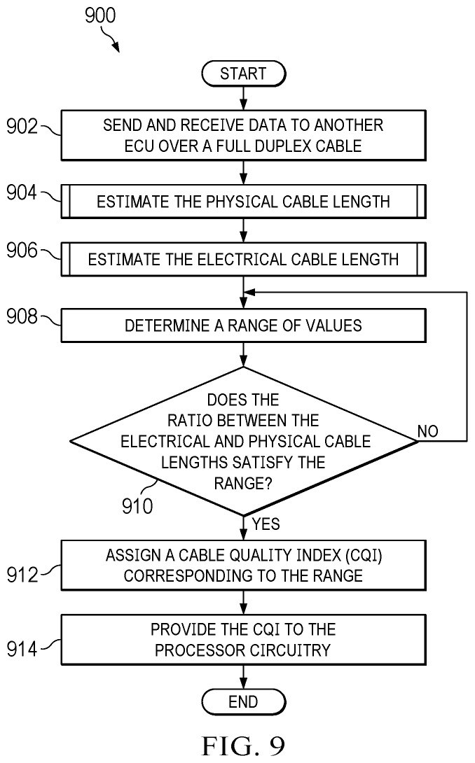

FIG. 9 is a flowchart representative of an example method that may be performed using example machine readable instructions and/or operations that can be executed and/or hardware configured to implement the receiver circuitry 208B of FIG. 2, and/or, more generally, the ECU 102B circuitry of FIG. 1 to compute Cable Quality Index (CQI). While the description of machine readable instructions and/or operations 900 may be made in reference to the ECU 102B, the flowchart of FIG. 9 may also be implemented by any of the ECUs 102 from FIG. 1.

The machine readable instructions and/or operations 900 begin when the ECU 102B sends and receives data to another ECU over a full duplex cable (Block 902). The ECU 102B may send and receive data with any of the other ECUs 102. The full duplex cable of block 902 may refer to any set of the Ethernet cables 106 that directly connects to the other ECU. For example, if the ECU 102B communicates with the ECU 102A in FIG. 1, the full duplex cable of block 902 may refer to Ethernet cables 106A, 106B, 106D, 106F, 106H.

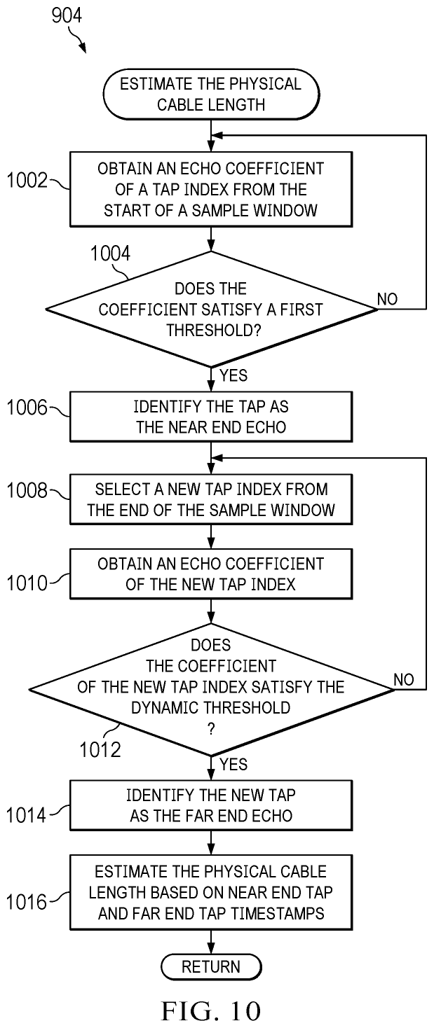

The physical length estimator circuitry 628 estimates the physical cable length. (Block 904). The physical length estimator circuitry 628 may determine a physical cable length estimation using data from the echo cancellation data path of the signal conditioner circuitry 518. Block 904 is described further in connection with FIG. 10.

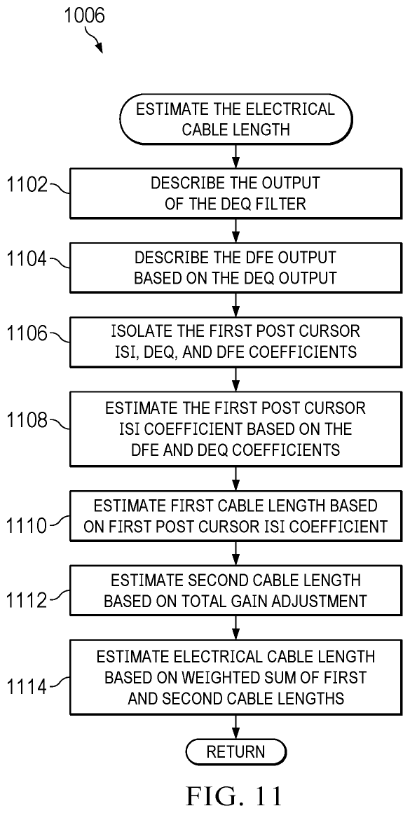

The electrical length estimator circuitry 626 estimates the electrical cable length. (Block 906). The cable length estimation may be a weighted average of a first ISI-based estimation and a second gain-based estimation. Block 906 is described further in connection with FIG. 11.

The CQI calculator circuitry 630 determines a range of values. (Block 908). The CQI calculator circuitry 630 may determine the range by selecting a range from a set of ranges. The number of ranges in the set and the size of each range at block 908 may be based on the number of possible CQI values. For example, a CQI value is an integer between 0 and 7, inclusive. In such examples, each of the eight possible CQI values may correspond to eight consecutive, mutually exclusive ranges of values. In other examples, a different number of possible CQI values and a different number of consecutive, mutually exclusive ranges exist.

The CQI calculator circuitry 630 determines whether the ratio between the electrical cable length and the physical cable length satisfies the range of values. (Block 910). In some examples, the CQI calculator circuitry 630 computes the CQI_Ratio as defined in equation (1) to determine whether the ratio of cable lengths satisfies the range. A ratio of cable lengths may satisfy a range if the CQI_Ratio is greater than the lower bound of the range and less than the upper bound of the range. If the ratio of cable lengths does not satisfy the range (Block 910: No), the machine readable instructions and/or operations 900 loop back to block 908, where the CQI calculator circuitry 630 determines a new range corresponding to a new CQI value.

If the ratio of cable lengths does satisfy the range (Block 910: Yes), the CQI calculator circuitry 630 assigns a CQI value corresponding to the range. (Block 912). For example, a CQI_Ratio within a first range of values is assigned CQI=0, a CQI_Ratio within a second range of values is assigned CQI=1, etc.

The CQI calculator circuitry 630 provides the CQI value to the processor circuitry 202B. (Block 914). The CQI value describes the quality of the full duplex cable of block 902.

FIG. 10 is a flowchart representative of an example method that may be performed using machine readable instructions that can be executed and/or hardware configured to implement physical length estimator circuitry of FIG. 6, and/or, more generally, an ECU of FIG. 1 to compute physical cable length as described in connection with FIGS. 3, 6, 7. Specifically, FIG. 10 describes how the example machine readable instructions and/or operations 900 implement block 904 of FIG. 9.

Execution of block 904 begins when the physical length estimator circuitry 628 obtains an echo coefficient of a tap index from the start of a sample window. (Block 1002). The echo estimator circuitry 615 may determine echo coefficients using a LMS algorithm or other appropriate algorithm as described previously. In the first iteration of block 904, the selected tap index may be the earliest timestamp within the sample window of tap indices used for echo cancellation.

The physical length estimator circuitry 628 determines whether the echo coefficient satisfies a first threshold. (Block 1004). In some examples, the echo coefficient satisfies the first threshold when the coefficient is greater or equal to the first threshold. In some examples, the first threshold is a pre-determined value based on empirical measurements of various cable types and lengths. If the echo coefficient does not satisfy the threshold, (Block 1004: No), the machine readable instructions and/or operations 900 loop back to 1002 where the physical length estimator circuitry 628 obtains another echo coefficient from the next chronologically ordered tap index.

If the echo coefficient does satisfy the first threshold, (Block 1004: Yes), the physical length estimator circuitry 628 identifies the tap index as the near end echo. (Block 1006). The physical length estimator circuitry 628 may then identify a new tap index from the end of the sample window. (Block 1008). In the first iteration of block 1008, the new tap index may be the last chronologically ordered tap index (e.g., the tap index that corresponds to the latest timestamp) in the sample window used for echo cancellation.

The physical length estimator circuitry 628 obtains an echo coefficient based on the new tap index. (Block 1010). The physical length estimator circuitry 628 then determines whether the coefficient of the new tap index satisfies a dynamic threshold. (Block 1012). In some examples, the dynamic threshold of block 1012 is satisfied if the magnitude of the echo coefficient is greater or equal to a threshold value specific to that tap index. In such examples, the tap-index specific threshold values may be stored in the physical length estimator circuitry 628 and may be empirically determined based on tests with a variety of brands of cables and a variety of cable lengths. Also or alternatively, the dynamic threshold of block 1012 is satisfied using gain equalization or local maxima estimation techniques as described previously.

If the coefficient of the new tap index does not satisfy the dynamic threshold (Block 1012: No), the machine readable instructions and/or operations 900 loop back to block 1008, where the physical length estimator circuitry 628 selects a new tap index. After a first iteration of block 1008 in which tap index n is chosen, the physical length estimator circuitry 628 selects the preceding chronological tap with index n−1 on a subsequent iteration of block 1008.

If the coefficient of the new tap index satisfies the dynamic threshold (Block 1012: Yes), the physical length estimator circuitry 628 identifies the new tap as the far end echo. (Block 1014). The physical length estimator circuitry 628 then estimates the physical cable length of the full duplex cable of block 902 based on near end tap and far end tap timestamps. (Block 1016). For example, the physical length estimator circuitry 628 uses the timestamps to implement equations (2) and (3) and determine the physical cable length estimation. The machine readable instructions and/or operations 900 return to block 906 after block 1016.

FIG. 11 is a flowchart representative of an example method that may be performed using machine readable instructions that can be executed and/or hardware configured to implement the electrical cable length estimator circuitry of FIG. 1, and/or, more generally, an ECU of FIG. 1 to compute an electrical cable length estimation. Specifically, FIG. 11 describes how the machine readable instructions and/or operations 900 implement block 906 of FIG. 9.

Execution of block 906 begins when the electrical length estimator circuitry 626 describes the output of a DEQ filter. (Block 1102). For example, the electrical length estimator circuitry 626 may describe the DEQ filter implemented in the equalizer circuitry 606 using equation (8), as described previously.

The electrical length estimator circuitry 626 describes a DFE output based on the DEQ output of block 1102. (Block 1104). For example, the electrical length estimator circuitry 626 describes the DFE output using equation (9) as described previously.

The electrical length estimator circuitry 626 isolates first post-cursor ISI, DEQ, and DFE coefficients. (Block 1106). For example, the electrical length estimator circuitry 626 isolates coefficients using equations (8), (9), and (10) as described previously.

The electrical length estimator circuitry 626 estimates the first post cursor ISI coefficient based on the DFE and DEQ coefficients. (Block 1108). For example, the electrical length estimator circuitry 626 estimates the first post cursor ISI coefficient using either equation (12) or equation (13) as described previously.

The electrical length estimator circuitry 626 estimates a first cable length based on the first post cursor ISI coefficient. (Block 1110). In some examples, the electrical length estimator circuitry 626 estimates the first cable length by referencing a look-up table or other data structure that characterizes the proportional relationship between ISI coefficients and cable length.

The electrical length estimator circuitry 626 estimates a second cable length based on the coarse and fine gain adjustment parameters provided by the CAGC circuitry 622 and FAGC circuitry 624. (Block 1112). In some examples, the electrical length estimator circuitry 626 estimates the first cable length by referencing a look-up table or other data structure that characterizes the proportional relationship between gain and cable length.

The electrical length estimator circuitry 626 estimates the electrical cable length based on a weighted average of the first and second cable lengths. (Block 1114). In some examples, the weights are pre-determined to represent the relative significance of ISI and gain for a particular cable length and type of cable. For example, if a change in quality of a particular cable length or cable type is shown empirically to affect the ISI of the cable more than the gain, the electrical length estimator circuitry 626 considers the first cable length from block 1110 a more significant factor than the second cable length of block 1112 when determining electrical cable length. The machine readable instructions and/or operations 900 return to block 908 after block 1114.

FIG. 12 is a block diagram of an example processor platform 1200 structured to execute and/or instantiate the machine readable instructions and/or the operations of FIGS. 9, 10, 11 to implement the ECU 102B of FIG. 1. The processor platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1200 includes example processor circuitry 1212, example volatile memory 1214, example non-volatile memory 1216, an example bus 1218, example interface circuitry 1220, example input devices, example output devices 1224, and an example mass storage device 1228. The processor circuitry 1212 is hardware. For example, the processor circuitry 1212 is implemented by one or more integrated circuits, logic circuits, FPGAs, microprocessors, CPUs, GPUs, DSPs, and/or microcontrollers from any desired family or manufacturer. The processor circuitry 1212 may be implemented by one or more semiconductor based (e.g., silicon based) devices. In this example, the processor circuitry 1212 implements processor circuitry 202B.

The processor circuitry 1212 includes an example local memory 1213 (e.g., a cache, registers, etc.). The processor circuitry 1212 communicates with the main memory 1214, 1216 via the bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 is controlled by one or more memory controllers.

The interface circuitry 1220 may be implemented by hardware in using any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 1220 implements transmitter circuitry 204B and receiver circuitry 208B.

The input device(s) 1222 are connected to the interface circuitry 1220. The input device(s) 1222 permit(s) a user to enter data and/or commands into the processor circuitry 1212. The input device(s) 1222 are implemented by, for example, an audio sensor, a microphone, a camera (still or video), a keyboard, a button, a mouse, a touchscreen, a track-pad, a trackball, an isopoint device, and/or a voice recognition system.

The output device(s) 1224 are also connected to the interface circuitry 1220. The output device(s) 1224 are implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220, thus, includes a graphics driver card, a graphics driver chip, and/or graphics processor circuitry such as a GPU.

The interface circuitry 1220 also includes a communication device such as a transmitter, a receiver, a transceiver, a modem, a residential gateway, a wireless access point, and/or a network interface to facilitate exchange of data with external machines (e.g., computing devices of any kind) by a network 1226. The communication is by, for example, an Ethernet connection, a digital subscriber line (DSL) connection, a telephone line connection, a coaxial cable system, a satellite system, a line-of-site wireless system, a cellular telephone system, an optical connection, etc.

The mass storage device(s) 1228 store software and/or data. Examples of such mass storage device(s) 1228 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

Machine readable instructions 1232, which may be implemented by the machine readable instructions of FIGS. 9, 10, 11, may be stored in the mass storage device 1228, in the volatile memory 1214, in the non-volatile memory 1216, and/or on a removable non-transitory computer readable storage medium such as a CD or DVD.

In this description, the term “and/or” (when used in a form such as A, B and/or C) refers to any combination or subset of A, B, C, such as: (a) A alone; (b) B alone; (c) C alone; (d) A with B; (e) A with C; B with C; and (g) A with B and with C. Also, as used herein, the phrase “at least one of A or B” (or “at least one of A and B”) refers to implementations including any of: (a) at least one A; (b) at least one B; and (c) at least one A and at least one B.

Example methods, apparatus and articles of manufacture described herein improve the precision and accuracy of cable quality estimations. Advantageously, the signal conditioner circuitry 518 computes the CQI based on a ratio of a physical length estimation, which does not change with quality, and an electrical length estimation, which does change with quality. Furthermore, the signal conditioner circuitry 518 estimates CQI while both ECUs 102A, 102B participate in normal communication over a full duplex Ethernet cable.

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

A device “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

A circuit or device described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Unless otherwise stated, “about,” “approximately,” or “substantially” preceding a value means+/−10 percent of the stated value, or, if the value is zero, a reasonable range of values around zero.

Modifications are possible in the described examples, and other examples are possible, within the scope of the claims.

What is claimed is:

1. A device comprising:
processor circuitry configured to establish a cable communication;
analog to digital converter circuitry configured to sample cable voltages over time;
echo estimator circuitry configured to determine echo coefficients corresponding to the cable voltages; and
physical length estimator circuitry configured to:
identify a first echo coefficient in the echo coefficients that satisfies a static threshold, the first echo coefficient corresponding to a near end echo;
identify a second echo coefficient in the echo coefficients that satisfies a dynamic threshold, the second echo coefficient corresponding to a far end echo; and
estimate the length of a cable for the cable communication based on the first echo coefficient and the second echo coefficient.

2. The device of claim 1, wherein an amount of time between the first echo coefficient and the second echo coefficient represents a round trip delay.

3. The device of claim 2, wherein the length of the cable is estimated using the round trip delay, a symbol rate, and a propagation delay.

4. The device of claim 1, wherein the cable is a full-duplex Ethernet cable.

5. The device of claim 1, wherein:
the device is a first device; and
the physical length estimator circuitry is further configured to estimate the length during cable communication between the first device and a second device.

6. The device of claim 1, wherein to identify the second echo coefficient, the physical length estimator circuitry is further configured to amplify the echo coefficients by a maximum gain supported by the device.

7. The device of claim 1, wherein to identify the second echo coefficient, the physical length estimator circuitry is further configured to:
identify a subset of consecutive coefficients from the echo coefficients; and
perform a nearest local maxima estimation technique on the subset of consecutive coefficients.

8. A device comprising:
processor circuitry configured to establish a cable communication;
analog to digital converter circuitry configured to sample cable voltages over time;
echo estimator circuitry configured to determine echo coefficients corresponding to the cable voltages;
equalizer circuitry configured to filter the cable voltages using a decision feedback equalizer (DFE) and a digital equalizer (DEQ); and
electrical length estimator circuitry configured to:
isolate a decision feedback equalizer (DFE) coefficient and a digital equalizer (DEQ) coefficient used by the equalizer circuitry;
estimate a post-cursor Intersymbol Interference (ISI) coefficient based on the DFE coefficient and the DEQ coefficient; and
estimate the length of a cable for the cable communication based on the post-cursor ISI coefficient.

9. The device of claim 8, wherein:
the length of the cable is a first cable length; and
the electrical length estimator circuitry is further configured to:
estimate a second cable length based on a gain adjustment; and
estimate the length of the cable based on a weighted average of the first cable length and the second cable length.

10. The device of claim 9, wherein the gain adjustment includes both first adjustment parameters and second adjustment parameters, wherein the second adjustment parameters change a gain value less than the first adjustment parameters.

11. The device of claim 9, wherein the electrical length estimator circuitry is further configured to assign weights to the first cable length and the second cable length based on at least one of: (a) a type of the cable, and (b) an expected cable length.

12. The device of claim 8, wherein the cable is a full-duplex Ethernet cable.

13. The device of claim 8, wherein:
the device is a first device; and
the electrical length estimator circuitry is further configured to estimate the length during cable communication between the first device and a second device.

14. A device comprising:
processor circuitry configured to establish a cable communication over a cable;
analog to digital converter circuitry configured to sample cable voltages over time;
echo estimator circuitry configured to determine echo coefficients corresponding to the cable voltages;
physical length estimator circuitry configured to estimate a first cable length for the cable communication based on a near end echo and a far end echo in the echo coefficients;
electrical length estimator circuitry configured to estimate a second cable length for the cable communication based on electrical characteristics of the cable; and
cable quality index (CQI) calculator circuitry configured to determine a CQI value based on a ratio of the first cable length to the second cable length and provide the CQI value to the processor circuitry.

15. The device of claim 14, wherein to identify the far end echo, the physical length estimator circuitry is further configured to amplify the echo coefficients by a maximum gain supported by the device.

16. The device of claim 14, wherein the far end echo, the physical length estimator circuitry is further configured to:
identify a subset of consecutive echo coefficients from the echo coefficients; and
perform a nearest local maxima estimation technique on the subset of consecutive echo coefficients.

17. The device of claim 14, wherein the electrical length estimator circuitry is further configured to:
estimate a third cable length for the cable communication based on a post-cursor Intersymbol Interference coefficient;
estimate a fourth cable length for the cable communication based on a gain adjustment; and
calculate the second cable length based on a weighted average of the third cable length and the fourth cable length.

18. The device of claim 17, wherein the gain adjustment includes both first adjustment parameters and second adjustment parameters, wherein the second adjustment parameters change a gain value less than the first adjustment parameters.

19. The device of claim 14, wherein:
the device is a first device;
the cable is a full-duplex Ethernet cable; and
the CQI calculator circuitry is further configured to determine the CQI value during cable communication between the first device and a second device.

20. The device of claim 14, wherein:
the cable voltages are first cable voltages;
the echo coefficients are first echo coefficients;
the CQI value is a first CQI value;
the echo estimator circuitry is further configured to determine second echo coefficients from a second cable voltages;
the electrical length estimator circuitry is further configured to estimate a third cable length for the cable communication based on electrical characteristics of the cable;
the third cable length is different from the second cable length due to degradation of the cable; and
the CQI calculator circuitry is further configured to determine a second CQI value based on a ratio of the first cable length and the third cable length.
